(19) United States
(12) Patent Application Publication
(10) Pub. No.: US 2017/0205105 A1
(43) Pub. Date: Jul. 20, 2017

(54) INTEGRATED THERMAL COMFORT CONTROL SYSTEM WITH SHADING CONTROL

(71) Applicant: DELTA T CORPORATION, Lexington, KY (US)

(72) Inventors: Brittany ADAM, Lexington, KY (US); Christian R. TABER, Lexington, KY (US); Jon OLSEN, Lexington, KY (US)

(21) Appl. No.: 15/326,693

(22) PCT Filed: Jul. 14, 2015
(86) PCT No.: PCT/US2015/040392

§ 371 Date: Jan. 17, 2017

Related U.S. Application Data
(60) Provisional application No. 62/024,229, filed on Jul. 14, 2014.

(51) Int. Cl. F24F 11/00; G05B 19/048; F04D 27/00; E05F 15/71; F04D 25/08

(52) U.S. Cl. CPC F24F 11/0012; E05F 15/71; F04D 25/088; F04D 27/001; F24F 11/0079; F24F 11/0015; F24F 11/0034; G05B 19/048; F24F 2011/0038; F24F 2011/0049; F24F 2011/005; F24F 2011/0058; F24F 2221/18; G05B 2219/2614

(57) ABSTRACT

An environmental control system for a space including at least one window adapted for admitting light into the space. The system comprises an environmental controller (such as a fan, a light, an HVAC system, a window, a window covering, or any combination of the foregoing) for regulating an environmental condition, and at least one first sensor, such as a radiant heat flux sensor, for sensing an amount of radiant energy associated with the space and generating an output. A controller is provided for controlling the operation of the environmental controller based on the sensor output. Related methods are also disclosed.

This application incorporates by reference the disclosures of U.S. Provisional Patent Application Ser. Nos. 61/720,679, 61/755,627, and 61/807,903, and also International Patent Application PCT/US13/067828.

This application claims the benefit of U.S. Provisional Patent Application Ser. No. 62/024,229, the disclosure of which is incorporated herein by reference.

### BACKGROUND

Ceiling fans have long been used in residences as an energy efficient means of increasing occupant thermal comfort in the summer and creating uniform air temperatures floor to ceiling in the winter. Typically the fans are manually controlled by the occupant to achieve acceptable levels of comfort. Automatic control systems for heating, ventilation and air conditioning systems (“HVAC”) in homes typically react to maintain a constant indoor air dry bulb temperature. Changes in indoor air conditions are primarily caused by sensible and latent heat transfer between the interior of the building and the outdoors. Shading devices, manual and automatic, are primarily utilized to control the light intensity in the space. However, the impact of direct solar heat gain through the fenestration into the building is not considered, nor is the potential use of the heat gain to advantage.

Accordingly, a need is identified for a system that intelligently coordinates ceiling fans, HVAC systems, fenestration/windows, and shading, which can greatly decrease the amount of fossil fuels required to maintain occupant thermal comfort.

### SUMMARY

An integrated environmental control system for a space bounded by a ceiling and including at least one window adapted for admitting light into the space includes an environmental controller and at least one first sensor for sensing an amount of radiant energy associated with the space and generating an output. A controller is provided for controlling the operation of the environmental controller based on the sensor output. The environmental controller may be selected from the group consisting of a fan, a light, an HVAC system, a window, a window covering, or any combination of the foregoing.

In one embodiment, the environmental controller comprises an automated window covering, the position of which (e.g., fully or partially opened and closed) may be regulated by the controller based on the sensor output. The controller is adapted for maintaining the automated window covering in at least partially closed condition (such as by only opening from the top in the case of a vertical) when a privacy setting is selected. In this or other embodiments, an artificial light may be provided (and optionally attached to a ceiling fan comprising the fan), and may also be regulated based on the sensor output.

The sensor may comprise a radiant heat flux sensor positioned adjacent to the at least one window. A second sensor may also be included, which may be selected from the group consisting of a light sensor, a temperature sensor (dry bulb, surface, etc.), a wind speed or direction sensor, a humidity sensor, an occupancy sensor, and any combination of two or more of the foregoing sensors. The controller may control the operation of the environmental controller based on a second output of the second sensor(s).

In one embodiment, the second sensor comprises a temperature sensor, and further including a set temperature provided by a user, and wherein the controller controls one or more of a ceiling fan, an HVAC unit, an automated window covering, and a light based on a comparison of the output of the temperature sensor and the set temperature. The system may also include an occupancy sensor, and the controller may control one or more of the ceiling fan, the HVAC unit, the automated window covering, and the light based on the output of the occupancy sensor.

The controller may be adapted for receiving information regarding a predicted weather condition and controlling the environmental control device based on the weather condition and historical reaction to a similar weather condition. The controller may also be adapted to regulate a window covering to close before the HVAC system turns on, including when the temperature is trending upward.

In one embodiment, the environmental controller comprises an automated window. The system may further include a wind speed or direction sensor for communicating with the controller to determine whether to open the window automatically. The controller may also be adapted for sending an alert to a user to indicate the desirability of opening or closing a window associated with the space based on the output of the sensor. In any embodiment, the controller may also be adapted to interact with the HVAC system to shut off when the window is open.

Another aspect of the disclosure pertains to an integrated environmental control system for a space bounded by a ceiling and including at least one window adapted for admitting light into the space. The system comprises a fan for causing air circulation within the space, a radiant heat flux sensor for sensing an amount of radiant energy associated with the space and generating an output, and a controller for controlling the operation of the fan based on the sensor output. The system may further include an HVAC system controlled by the controller based on the sensor output, and the controller may regulate one or both of the HVAC system and the fan. The system may further include an automated window covering, and the controller may regulate the automated window covering based on the sensor output. The system may also include an automated window, and the controller may regulate the automated window based on the sensor output.

A further aspect of the disclosure relates to an integrated environmental control system for a space. The system comprises at least one window adapted for being opened to at least one position for admitting air into the space. A sensor is provided for sensing a condition in the space and generating an output. A controller for also provided taking a specified action to regulate the window position based on the sensor output.

In one embodiment, the controller issues a control signal for modulating a motor associated with the window to cause the window to open (or perhaps two or more windows to promote a breeze). In another embodiment, the controller issues an alert to a user relative to the opening of the window. The alert may be in the form of an electronic message including user-perceptible instructions. The sensor may be selected from the group consisting of a temperature sensor (dry bulb, surface, etc.), a humidity sensor, an occupancy sensor, a radiant flux sensor, a wind speed sensor, a solar intensity sensor, or any combination of two or more of the foregoing sensors.

Still a further aspect of the disclosure relates to an integrated environmental control system for a space bounded by a ceiling and including at least one window adapted for admitting light into the space. The system comprises a fan for circulating air within the space and an automated window device (covering or shading) for selectively controlling a state of the window. A sensor is provided for sensing a condition associated with the space, along with a controller for controlling the operation of the fan and the window covering based on the sensor output.

In one embodiment, the automated window device comprises an automated blind for controlling the amount of light passing through the window into the space as the state of the window. In this or another embodiment, the automated window device comprises an automated window for controlling the amount of air passing through a window opening into the space as the state of the window. The controller may control other devices as well.

Yet another aspect of the disclosure pertains to a method of controlling an environmental condition in a space. The method comprises regulating an environmental controller associated with the space based on a sensed radiant heat flux associated with the space.

Still another aspect of the disclosure relates to a method of controlling an environmental condition in a space. The method comprises controlling at least one window adapted for being opened to at least one position for admitting air into the space based on a sensed condition in the space.

A portion of the disclosure also pertains to a method of controlling an environmental condition in a space. The method comprises controlling one or more of a window, a window covering and a fan based on a detected value of a temperature in the space. When the detected temperature is above or below a pre-determined value, the method includes the step of activating an additional system for regulating the temperature in the space. The additional system may comprise an HVAC system.

This disclosure also relates to a method for controlling lighting in a space including a window. The method comprises providing a controller to regulate an automated window covering to control an amount of natural light in the space and regulate an artificial light to control an amount of artificial light in the space. The controller may be adapted to increase the amount of artificial light when the covering is closed and decrease the amount of artificial light when the covering is open.

Still, this disclosure further relates to a method of regulating environmental conditions in a space including a window. Based on a pre-determined effective temperature setting, a state of occupancy, and a radiant heat flux value, the method comprises regulating: (i) a fan for circulating air in the space; (ii) an HVAC system for controlling the dry bulb temperature of the space; (iii) a covering for at least partially covering the window; and (iv) a light for providing artificial light to the space.

In one embodiment, if the space is occupied and heating is desired, the HVAC unit is activated to supply heated air to the space in an effort to reach the pre-determined effective temperature setting, the fan is regulated on at a minimal speed to avoid creating a draft, the covering is regulated to uncover the window if the radiant heat flux value exceeds a predetermined amount, and the light is regulated to provide for a pre-determined amount of light. If the space is unoccupied and heating is desired, the HVAC system is activated to supply heated air to the space in an effort to reach the pre-determined effective temperature setting, the fan is regulated on at a minimal speed, and the covering is regulated to uncover the window if the radiant heat flux value exceeds a predetermined amount, and light is regulated to provide for no light or a minimal amount of light. If the space is occupied and cooling is desired, the HVAC system is activated to supply cooled air to the space in an effort to reach the pre-determined effective temperature setting, the fan is regulated on at a speed greater than a minimal speed, the covering is regulated to cover the window if the radiant heat flux value exceeds a predetermined amount, and the light is regulated to provide for a pre-determined amount of light. If the space is unoccupied and cooling is desired, the HVAC system is activated to supply cooled air to the space in an effort to reach the pre-determined effective temperature setting, the fan is regulated to be off, and the covering is regulated to cover the window if the radiant heat flux value exceeds a predetermined amount.

Also related to this disclosure is a method of using a controller to regulate a first window covering on a first window based upon a predicted or actual amount of natural light available to pass through the first window. The method may further include using the controller to regulate a second window covering on a second window based upon the predicted or actual amount of natural light available to pass through the second window. The regulating steps may be performed based upon a direction each window faces and the time of day, or based upon a sensed radiant heat flux associated with the first or second window.

Furthermore, an aspect of the disclosure relates to a method of regulating environmental conditions in a space. The method involves using a controller to control the operation of an environmental control device, such as window to admit air into the space or a window covering to admit light into the space based on a predicted weather condition. The controlling step may be performed based on a comparison of the predicted weather condition and a control implemented as a result of a similar historic weather condition, and may involve controlling one or both of a fan in the space and an HVAC system for supplying air to the space.

Another aspect of the disclosure relates to a method of regulating environmental conditions in a space. The method comprises comparing a predicted weather condition with a historical weather condition and, based on the comparison, regulating an environmental control device associated with the space. The regulating step may comprise operating the environmental control device according to a current protocol that corresponds to a past protocol of operation during the historical weather condition.

In any of these aspects, or an additional aspect, a system for or method of conditioning a space using thermal energy is provided. This includes determining whether a partition in the space (floor, wall, ceiling, etc.) is useful for providing heat to the space. Upon determining that the floor or other partition is useful for providing heat to the space, the system or method regulates an environmental condition of the space (such as by turning off an associated fan for a predetermined length of time).

This aspect may include determining an amount of radiant energy in the space, and also determining the thermal storage potential of the partition or floor. The determining process may comprise determining a learned thermal reaction. Predicting a heat need for the space prior to the determining may also be done, as well as determining whether the space is occupied and regulating accordingly.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of an exemplary fan having a motor assembly, a hub assembly, a support, a plurality of fan blades, and a mounting system coupled with joists;

FIG. 2 depicts another perspective view of an exemplary fan;

FIG. 3 depicts a perspective view of an exemplary thermal comfort control system utilizing circulating fans;

FIG. 4 depicts a perspective view of a second embodiment of a thermal comfort control system utilizing circulating fans;

FIG. 5 depicts a flow diagram of an exemplary thermal comfort control process, that utilizes the climate control system of FIG. 3;

FIG. 6 depicts a detailed flow diagram of the exemplary thermal comfort control process of FIG. 4 in which the master control system has automatically chosen the “Occupied Heating” mode;

FIG. 7 depicts a detailed flow diagram of the exemplary thermal comfort control process of FIG. 4 in which the master control system has automatically chosen the “Unoccupied Heating” mode;

FIG. 8 depicts a detailed flow diagram of the exemplary thermal comfort control process of FIG. 4 in which the master control system has automatically chosen the “Occupied Cooling” mode;

FIG. 9 depicts a detailed flow diagram of the exemplary thermal comfort control process of FIG. 4 in which the master control utilizes the “Occupied Cooling” mode according to a second embodiment;

FIG. 10 depicts a detailed flow diagram of the exemplary thermal comfort control process of FIG. 4 in which the master control system has automatically chosen the “Unoccupied Cooling” mode;

FIG. 11 depicts a detailed flow diagram of an exemplary control for shading in “Occupied Heating” mode;

FIG. 12 depicts a detailed flow diagram of an exemplary control for shading in “Unoccupied Heating” mode, and also illustrates the optional use of thermal storage in connection with the floor;

FIG. 13 depicts a detailed flow diagram of an exemplary control for shading in “Occupied Cooling” mode; and

FIG. 14 depicts a detailed flow diagram of an exemplary control for shading in “Unoccupied Cooling” mode.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the claimed invention. Other examples, features, aspects, embodiments, and advantages of the invention will become apparent to those skilled in the art from the following description, which includes by way of illustration, one or more of the best modes contemplated for carrying out the invention. As will be realized, the invention is capable of other different and obvious aspects, all without departing from the invention. Accordingly, the drawings and descriptions should be regarded as illustrative in nature and not restrictive.

I. Exemplary Fan Overview

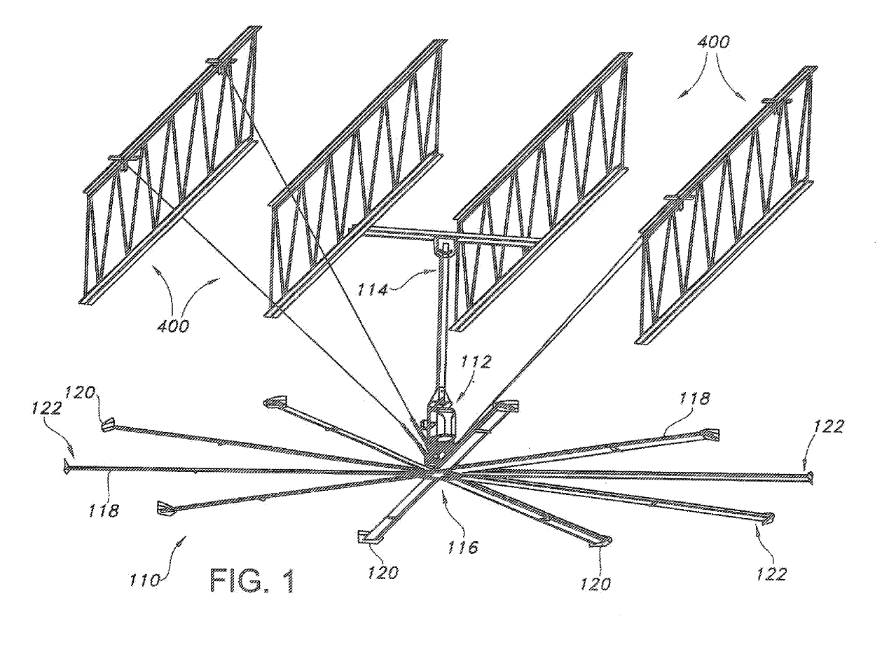

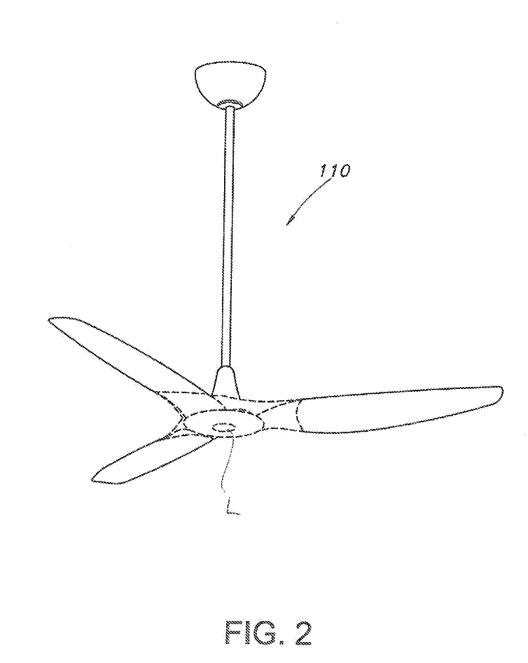

Referring to FIG. 1, a fan (110) of the present example comprises a motor assembly (112), a support (114), a hub assembly (116), and a plurality of fan blades (118). In the present example, fan (110) (including hub assembly (116) and fan blades (118)) has a diameter of greater than about 3 feet and, more specifically, approximately 8 feet. In other variations, fan (110) has a diameter between approximately 6 feet, inclusive, and approximately 24 feet, inclusive. Alternatively, fan (110) may have any other suitable dimensions, such as a 3-7 foot overhead fan having an ornamental design for use in commercial or residential spaces (see FIG. 2), and having a support (114) mounted to the ceiling (C). The particular type of fan (110) used is not considered important to controlling thermal comfort, but the concepts disclosed may have particular applicability to the types of fans for circulating air within a space or room, such as overhead ceiling fans depending from a ceiling with exposed, rotating blades, as shown in the drawings. Any embodiment disclosed herein may be considered to operate in connection with such overhead ceiling fan(s), at a minimum, but could also be applied to portable fans, standing fans, wall fans, or the like.

Support (114) is configured to be coupled to a surface or other structure at a first end such that fan (110) is substantially attached to the surface or other structure. As shown in FIG. 1, one such example of a structure may be a ceiling joist (400). Support (114) of the present example comprises an elongate metal tube-like structure that couples fan (110) to a ceiling, though it should be understood that support (114) may be constructed and/or configured in a variety of other suitable ways as will be apparent to one of ordinary skill in the art in view of the teachings herein. By way of example only, support (114) need not be coupled to a ceiling or other overhead structure, and instead may be coupled to a wall or to the ground. For instance, support (114) may be positioned on the top of a post that extends upwardly from the ground. Alternatively, support (114) may be mounted in any other suitable fashion at any other suitable location. This includes, but is not limited to, the teachings of the patents, patent publications, or patent applications cited herein.

Motor assembly (112) of the present example comprises an AC induction motor having a drive shaft, though it should be understood that motor assembly (112) may alternatively comprise any other suitable type of motor (e.g., a permanent magnet brushless DC motor, a brushed motor, an inside-out motor, etc.). In the present example, motor assembly (112) is fixedly coupled to support (114) and rotatably coupled to hub assembly (100). Furthermore, motor assembly (112) is operable to rotate hub assembly (116) and the plurality of fan blades (118).

Fan blades (118) of the present example may further include a variety of modifications. By way of example only, a winglet (120) may be coupled to the second end (122) of fan blade (118). Winglets (120) may be constructed in accordance with some or all of the teachings of any of the patents, patent publications, or patent applications cited herein. It should also be understood that winglet (120) is merely optional. For instance, other alternative modifications for fan blades (118) may include end caps, angled airfoil extensions, integrally formed closed ends, or substantially open ends.

II. Exemplary Thermal Comfort Control System

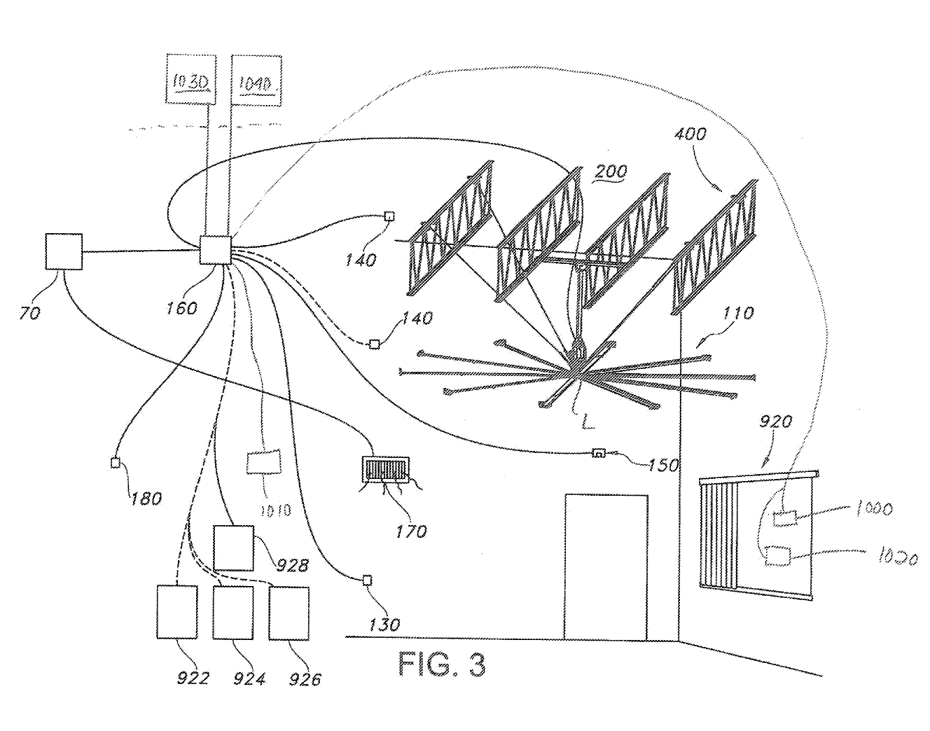

It may be desirable to utilize exemplary fan (110) disclosed above to improve the efficiency of a typical climate control system, thereby creating a thermal comfort control system (100). Exemplary fan (110) described above would improve the efficiency of a typical climate control system by circulating the air, thus preventing the formation of pockets of heated or cooled air in locations that do not benefit the occupants, or in which an increased difference between indoor and outdoor temperatures across an exterior wall and roof increases the rate of heat transfer through the surface. Another added benefit of exemplary fan (110), is that when the circulating air created by fan (110) comes into contact with human skin, the rate of heat transfer away from the body increases, thus generating a cooling effect which allows for more efficient use of the HVAC system during periods of cooling. By way of example only, an otherwise standard climate control system may further include at least one exemplary fan (110), at least one low-elevation sensor (130), at least one high-elevation sensor (140), at least one occupancy sensor (150), at least one master control system (160), at least one HVAC system (170), and optionally at least one external sensor (180) as shown in FIG. 3.

While exemplary thermal comfort control system (100) is shown as including fan (110) as described above, it should be understood that any other type of fan may be included in exemplary thermal comfort control system (100), including combinations of different types of fans. Such other fans may include pedestal mounted fans, wall mounted fans, or building ventilation fans, among others. It should also be understood that the locations of sensors (130, 140, 150, 180) as shown in FIG. 3 are merely exemplary. Sensors (130, 140, 150, 180) may be positioned at any other suitable locations, in addition to or in lieu of the locations shown in FIG. 3. By way of example only, high-elevation sensor (140) may be mounted to a joist, to the fan, to the upper region of a wall, and/or in any other suitable location(s). Various suitable locations where sensors (130, 140, 150, 180) may be located will be apparent to those of ordinary skill in the art in view of the teachings herein. Furthermore, it should be understood that sensors (130, 140, 150, 180) themselves are mere examples. Sensors (130, 140, 150, 180) may be modified or omitted as desired.

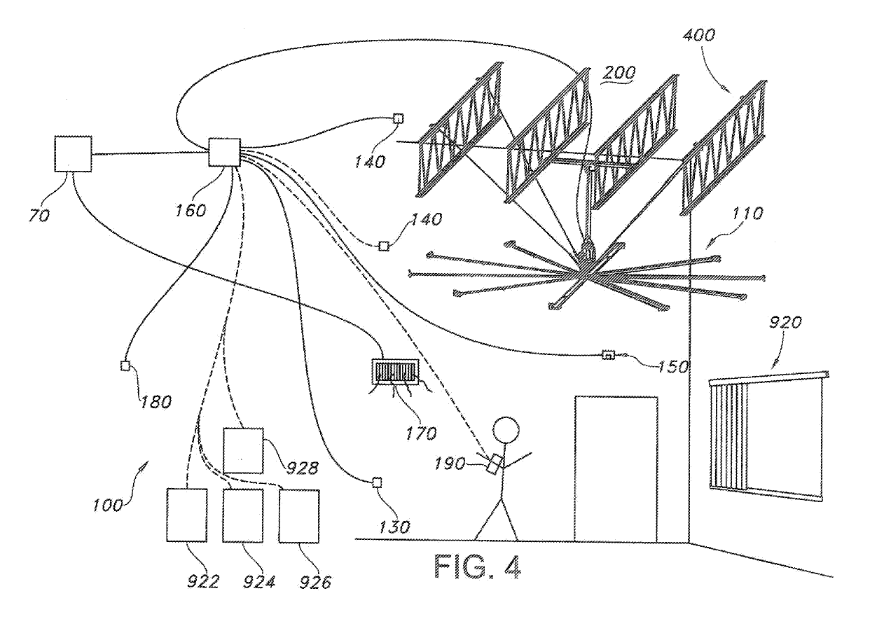

Furthermore, various other kinds of sensors may be used as desired, in addition to or in lieu of one or more of sensors (130, 140, 150, 180). For example, a physiological sensor (190) associated with a user may be used to sense a physiological condition of the user, as illustrated in FIG. 4. The sensed physiological condition may relate to the user's metabolic equivalent of task (MET), heart rate, pulse, blood pressure, body (e.g., skin surface) temperature, respiration, weight, perspiration, blood oxygen level, galvanic skin response, or any other physiological condition. By way of example, the physiological sensor (190) may comprise a wearable sensor such as a wristband, armband, belt, watch, glasses, clothing accessory, or any other sensor capable of being worn by the user or attached to the user's body. Additionally, the physiological sensor (190) may comprise an internal sensor, such as a sensor that has been embedded in the user or ingested by the user.

In any embodiment, the physiological sensor (190) may be capable of transmitting data about the user's physiological condition either directly to the master control system (160), or indirectly to the master controller system (160) via an intermediate device. Communication between the physiological sensor (190) and the master controller (160) may be wireless, such as through the use of RF transmissions, Bluetooth, WIFI, or infrared technology. In the case of communication via an intermediate device, said device may comprise a computer or a portable computing device such as a tablet computer, smartphone, or any other device capable of receiving data from the physiological sensor (190) and transmitting said data to the master controller (160).

Furthermore, system (100) may receive information from one or more other sources, including but not limited to online sources. For instance, system (100) may receive one or more temperature values, other values, procedures, firmware updates, software updates, and/or other kinds of information via the internet, through wire or wirelessly. Various suitable ways in which system (100) may communicate with the internet and/or other networks, as well as various types of information that may be communicated, will be apparent to those of ordinary skill in the art.

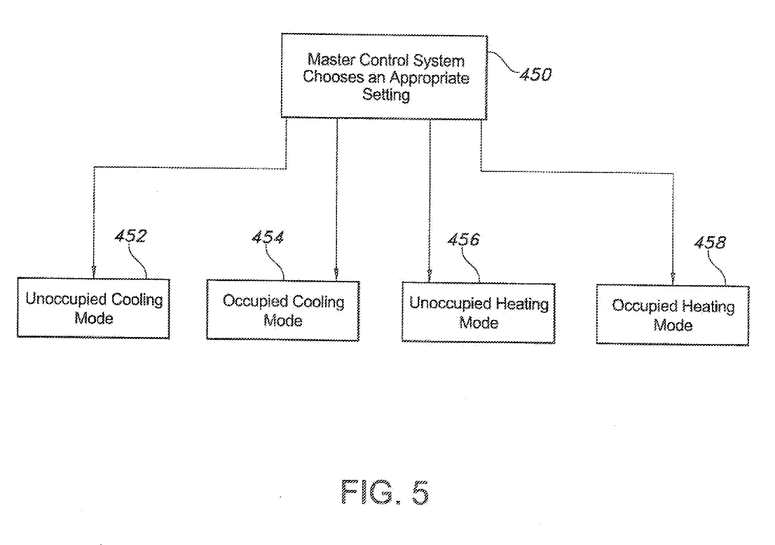

As shown in FIG. 4, in such an exemplary thermal comfort control system (100), master control system (160) may determine an appropriate comfort control setting (450) based a number of conditions which may include external dry bulb temperature, room occupancy, and/or time of day, among other factors which may exist. As merely an example of such a comfort control setting determination (450), master control system (160) may choose between “Heating” or “Cooling” based upon the internal and/or external sensed dry bulb temperature, the master control system may then choose between “Occupied” or “Unoccupied” based upon the sensed occupancy. These conditions, as well as others, may be communicated to master control system (160) by the sensors mentioned above (130, 140, 150, 180, 190) and in a manner described below. Although the appropriate comfort control setting is determined by master control system (160) in exemplary thermal comfort control system (100) described above, other configurations of a thermal comfort control system (100) may allow for an occupant to choose between multiple comfort control settings. The comfort control settings may include, among other settings: “Occupied Heating” mode (458), “Unoccupied Heating” mode (456), “Occupied Cooling” mode (454), and “Unoccupied Cooling” mode (452) (see FIG. 5). Each setting may have a programmable effective temperature set range associated with it, as well as the option to operate fan (110) as a part of a sequence of operations of HVAC system (170), both in response to the effective temperature being outside the relevant set range, and also, where appropriate, in response to other conditions such as a difference between the high-elevation temperature and the low-elevation temperature in a particular room as described below.

High-elevation sensor(s) (140) and low-elevation sensor(s) (130) will sense the temperature at various locations throughout a room. The sensors may sense the air-dry bulb temperature, or wet bulb temperature, but do not necessarily have to sense either. High-elevation sensor(s) (140) and low-elevation sensor(s) (130) may also sense relative humidity, air speed, light levels, or other conditions which may exist. Of course, separate dedicated sensors may also be used to sense such other conditions which may exist.

In some versions, detected light levels may factor into control procedures by indicating whether it is sunny outside. For instance, a light sensor (such as, for example, a photocell) may capture ambient light within a room during daylight hours. Accounting for any light from a man-made light source (L), system (100) may react to light levels indicating significant sunlight reaching a room through one or more windows, such as by increasing cooling effects (such as by regulating the fan speed (e.g., increasing the speed based on more light being detected) and/or activating the HVAC system) during summer time or by reducing heating effects during winter time under the assumption that the sunlight itself will provide at least a perceived heating effect on occupants of the room.

As another merely illustrative example, a light sensor may indicate whether a room is occupied at night (e.g., a lit room at a time associated with night indicates current occupancy or expected occupancy of the room). As yet another merely illustrative example, detected light levels may trigger automated raising or lowering of blinds at windows of a room, either completely or to a particular level or amount of opening. Other suitable ways in which light levels may be factored into a control procedure for system (100) will be apparent to those of ordinary skill in the art in view of the teachings herein. Of course, some versions of system (100) may simply lack light sensing capabilities.

As shown in FIG. 3, high-elevation sensor(s) (140) may be located on fan (110), ceiling (200), or elsewhere in a room. Low-elevation sensor(s) (130) may be located at or near the level in which the room will be occupied. Optionally, the exemplary thermal comfort control system may include external sensors (180) that will sense the dry bulb temperature, relative humidity, barometric pressure, or other conditions that may exist external to the building envelope. Finally, occupancy sensor(s) (150) will sense the presence of occupants within a room. Occupancy sensor(s) (150) may be placed throughout a room, but may be especially effective in places of entry, as shown in FIG. 3. Sensors (130, 140, 150, 180) may be placed in a single room or zone, or may be placed in multiple rooms or zones. Measurements from high-elevation sensor(s) (140), low-elevation sensor(s) (130), external sensor(s) (180), and occupancy sensor(s) (150) may be communicated to the master control system (160). As a merely illustrative example, temperature sensors (130, 140) described above may be configured in accordance with the teachings of U.S. Pat. Pub. No. 2010/0291858, entitled “Automatic Control System For Ceiling Fan Based On Temperature Differentials,” published Nov. 18, 2010, the disclosure of which is incorporated by reference herein. Of course, the locations of sensors (130, 140, 150, 180) described above and shown in FIG. 3, are merely exemplary, and any other suitable location may be utilized.

Master control system (160) may include a processor capable of interpreting and processing the information received from sensors (130, 140, 150, 180, 190) to determine when the temperature is outside the relevant set range and also to identify temperature differentials that may exist throughout a room. The processor may also include control logic for executing certain control procedures in order to effectuate an appropriate control response based upon the information (temperature, air speed, relative humidity, etc.) communicated from sensors (130, 140, 150, 180, 190) and the setting automatically chosen by master control system (160) or manually chosen by the occupant. An appropriate control response may be carried out through commands communicated from master control system (160) to fan(s) (110) and/or HVAC system (170) based on the control procedures. By way of example only, fan(s) (110) may be driven through a control procedure that varies fan speed as a function of sensed temperature and humidity. Some such versions may provide a control procedure like the one taught in U.S. Pat. Pub. No. 2010/0291858, the disclosure of which is incorporated by reference herein. In some settings, varying fan speed as a function of sensed dry bulb or surface temperature and humidity may assist in avoiding condensation on objects within the same room as fan(s) (110); and/or may provide other effects.

As a merely illustrative example, the basis of the control logic may be derived from the thermal comfort equations in ASHRAE Standard 55-2013 (incorporated herein by reference) and/or other relevant comfort related theory or research. The air speed and effective temperature, as described below, may be derived from the SET method of ASHRAE Standard 55-2013 and/or other relevant comfort related theory or research. The control logic may incorporate such factors as dry bulb temperature, relative humidity, air speed, light levels, physiological condition of a user, and/or other conditions which may exist; to determine how to most efficiently achieve acceptable levels of occupant thermal comfort. Master control system (160) may learn the thermal preferences of the occupants during an initial “learning period.” Master control system (160) may then apply the control logic to the thermal preferences of the occupant to reduce the energy consumption of HVAC system (170) and fan(s) (110). In the case of the master control system (160) utilizing a measured physiological condition of the user, such as MET, the derivation of relevant parameters according to the SET method and/or other relevant comfort related theory or research may utilize real-time physiological measurements of the user(s) in the space, rather than default settings chosen during an initial set-up period. Accordingly, these derivations may be performed more quickly and more accurately through a more accurate assessment of the environment and system.

Communication between master control system (160), HVAC system (170), fan(s) (110), and various sensors (130, 140, 150, 180, 190) may be accomplished by means of wired or wireless connections, RF transmission, infrared, Ethernet, or any other suitable and appropriate mechanism. Master control system (160) may also be in communication with additional devices (which may include computers, portable telephones or other similar devices) via the Local Area Network, internet, cellular telephone networks or other suitable means, permitting manual override control or other adjustments to be performed remotely. Thermal comfort control system (100) may be controlled by wall-mounted control panels and/or handheld remotes. In some versions, thermal comfort control system (100) may be controlled by a smart switch, an application on a smart phone, other mobile computing device, or a ZigBee® controller by ZigBee Alliance of San Ramon, Calif. Such an application may include on/off, dimming, brightening, and Vacation Mode among other options.

A smart switch could include sensors (130, 140, 150, 180), including one adapted for being positioned in a standard wall mounted box for receiving a conventional “Decora” style of light switch. Such a smart switch could be retrofitted within a space to provide information from sensors (130, 140, 150, 180) to master control system (160). A smart switch may also comprise master control system (160) in addition to or in lieu of sensors (130, 140, 150, 180). Such a smart switch could be retrofitted within a space to operate as master control system (160) of exemplary thermal comfort control system (100) by controlling any existing HVAC system (170), fan(s) (110), and/or any other climate and environmental control products.

As a merely illustrative example, suppose that master control system (160) had automatically chosen and/or the occupant had manually chosen “Occupied Heating” mode (458), and set the effective temperature at 70° F. As shown in FIG. 4, if the high-elevation dry bulb temperature is warmer than the low-elevation temperature, the fan speed may be increased to “Winter Maximum Speed” (512) to circulate the warmer air throughout the room. “Winter Maximum Speed” is 30% of the maximum fan speed (512) in the present example, though it should be understood that any other suitable speed may be used. If however, the high-elevation dry bulb temperature is cooler than the low-elevation drub bulb temperature, the fan speed may remain constant at “Winter Minimum Speed” (514) to prevent air pockets from forming throughout the room. The “Winter Minimum Speed” is 15% of the maximum fan speed (514) in the present example, though it should be understood that any other suitable speed may be used. If at any time, low-elevation temperature sensor(s) (130) communicates to master control system (160) that the effective temperature has fallen to 69.5° F. (520), master control system (160) may first compare the high-elevation temperature and low-elevation dry bulb temperature (510); and if the high-elevation temperature is warmer than the low-elevation dry bulb temperature, the fan speed may be increased to “Winter Maximum Speed” (512) to circulate the warmer air throughout the room prior to activating HVAC system (170). After allowing suitable time for the warm air to circulate the room, the dry bulb temperature may again be measured, or continuous measurements may be taken as part of a continuous feedback loop, and an appropriate control response may then be taken by master control system (160). If at any time, low-elevation temperature sensor(s) (130) communicates to master control system (160) that the dry bulb temperature has fallen to 69° F. (530), master control system (160) will activate HVAC system (170) (532). Of course, any other suitable temperature values may be used in “Occupied Heating” mode (458).

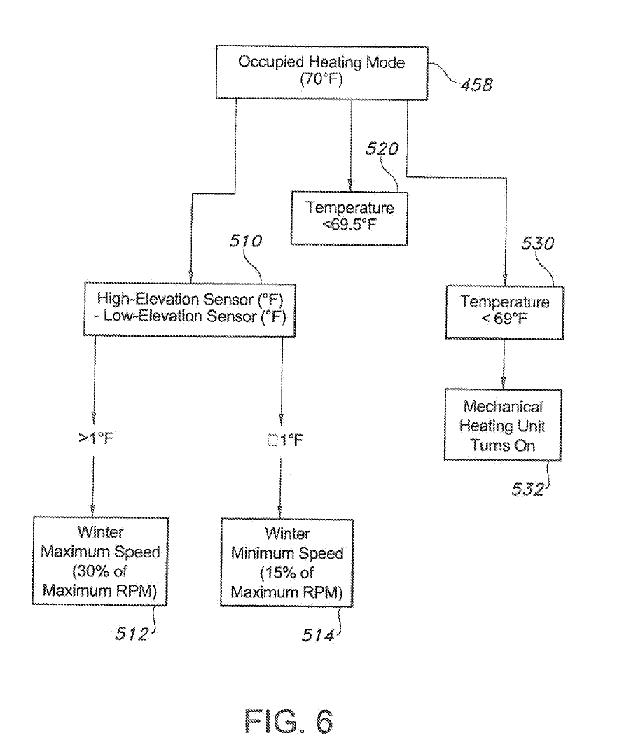

As another merely illustrative example, suppose that master control system (160) had automatically chosen and/or the occupant had manually chosen “Unoccupied Heating” mode (456), and set the effective temperature at 55° F. As shown in FIG. 6, if the high-elevation dry bulb temperature is warmer than the low-elevation dry bulb temperature, the fan speed may be increased to “Winter Maximum Speed” (612) to circulate the warmer air throughout the room. “Winter Maximum Speed” is 30% of the maximum fan speed (612) in the present example, though it should be understood that any other suitable speed may be used. If however, the high-elevation dry bulb temperature is cooler than the low-elevation temperature, the fan speed may remain constant at “Winter Minimum Speed” (614) to prevent air pockets from forming throughout the room. The “Winter Minimum Speed” is 15% of the maximum fan speed (614) in the present example, though it should be understood that any other suitable speed may be used. If at any time, low-elevation temperature sensor(s) (130) communicates to master control system (160) that the dry bulb temperature has fallen to 54.5° F. (620), master control system (160) may first compare the high-elevation dry bulb temperature and the low-elevation dry bulb temperature (610); and if the high-elevation dry bulb temperature is warmer than the low-elevation dry bulb temperature, the fan speed may be increased to “Winter Maximum Speed” (612) to circulate the warmer air throughout the room prior to activating HVAC system (170).

After allowing suitable time for the warm air to circulate the room, the temperature may again be measured, or continuous measurements may be taken as part of a continuous feedback loop, and an appropriate control response may then be taken by master control system (160). If at any time, low-elevation dry bulb temperature sensor(s) (130) communicates to master control system (160) that the temperature has fallen to 54° F. (630), master control system (160) will activate HVAC system (170) (632). Of course, any other suitable temperature values may be used in “Unoccupied Heating” mode (456).

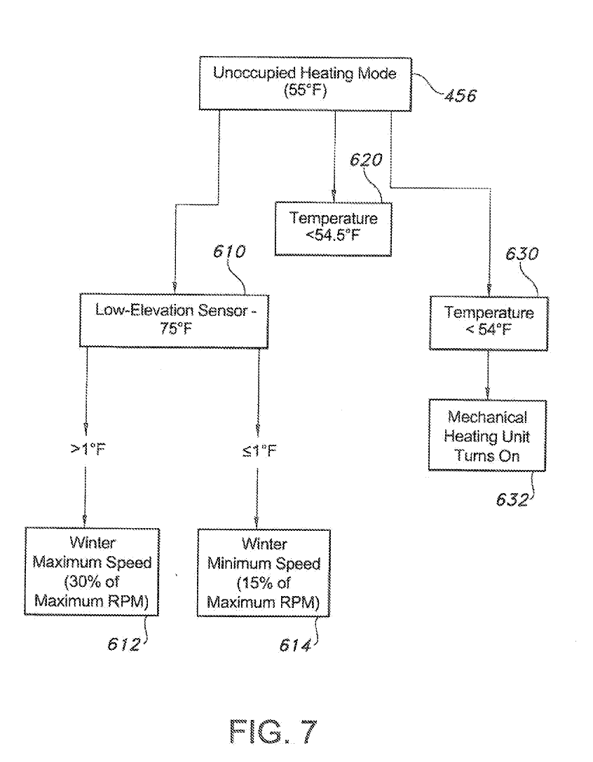

As yet another merely illustrative example, suppose that master control system (160) had automatically chosen and/or the occupant had manually chosen “Occupied Cooling” mode (454), and set the effective temperature at 80° F. and master control system (160) determined the optimum relative humidity to be 55%. As shown in FIG. 7, if low-elevation sensor(s) (130) communicates to master control system (160) that the low-elevation effective temperature has raised to a point within 5° F. of set temperature (710), master control system may activate fan(s) (110). Master control system (160) may increase the speed of fan(s) (110) as the low-elevation effective temperature approaches set effective temperature (712, 714, 716, 718, 720, 722) until the fan speed reaches 100% of the maximum fan speed (722), as shown in FIG. 6. The air movement created by fan(s) (110) creates a lower effective temperature by increasing the rate of heat transfer from the body.

Master control system (160) may adjust the set dry bulb temperature to a higher actual set temperature that accounts for the perceived cooling effect (724), while maintaining an effective temperature at the original set temperature, 80° F. The control logic utilized by master control system (160) to determine the perceived temperature may be derived from the SET method of the ASHRAE Standard 55-2013 and/or other relevant comfort related theory or research. The effective temperature may be based upon the dry bulb temperature, relative air humidity, and/or air speed, among other conditions which may exist. If the effective temperature rises above original set effective temperature (730), then master control system (160) may activate HVAC system (170) (732). If the relative humidity level rises above the optimum relative humidity (740), then master control system (160) may also activate HVAC system (170) (742) (i.e. regardless of what the actual or effective temperature may be). Of course, any other suitable temperature and/or relative humidity level values and/or fan speeds may be used in “Occupied Cooling” mode (454).

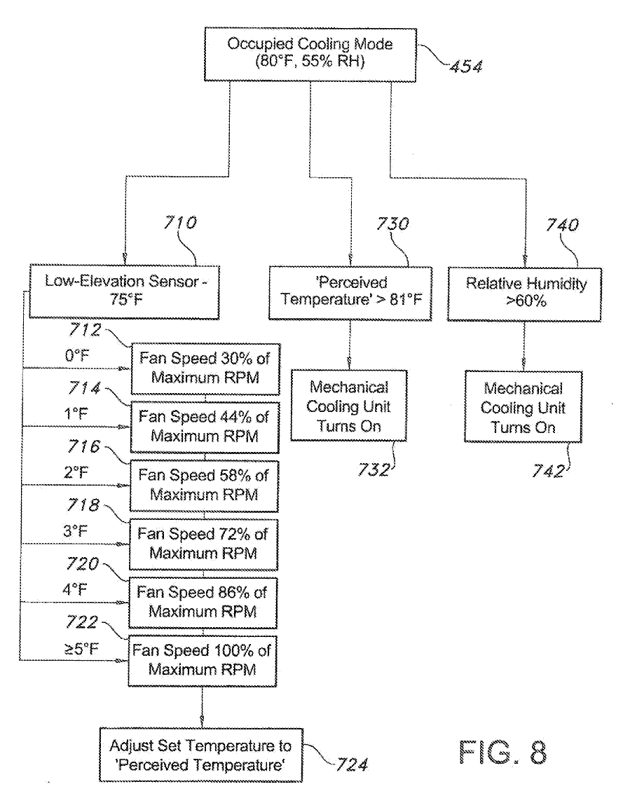

In a similar illustrative example as shown in FIG. 8, the master control system (16) may have automatically chosen and/or the occupant may have manually chosen “Occupied Cooling” mode (454), and set the temperature at 80° F. and master control system (160) may have determined the optimum relative humidity to be 55%. In this embodiment, a physiological sensor (190) may communicate to the master control system (160) a value of a physiological condition of a user, such as MET. The physiological sensor (190) may alternately measure one or more of heart rate, pulse, blood pressure, body (e.g., skin surface) temperature, respiration, weight, perspiration, blood oxygen level, galvanic skin response, or an accelerometer, or any combination of the foregoing. The sensor may be wearable, and may be positioned on a wristband, armband, belt, watch, glasses, clothing, clothing accessory (e.g., a hat, earring, necklace), or any combination thereof. Alternatively, the sensor may be embedded or ingested. The sensor may close an associated window device, such as a shade or covering, if it is determined that the occupants are hot and sunny conditions are present.

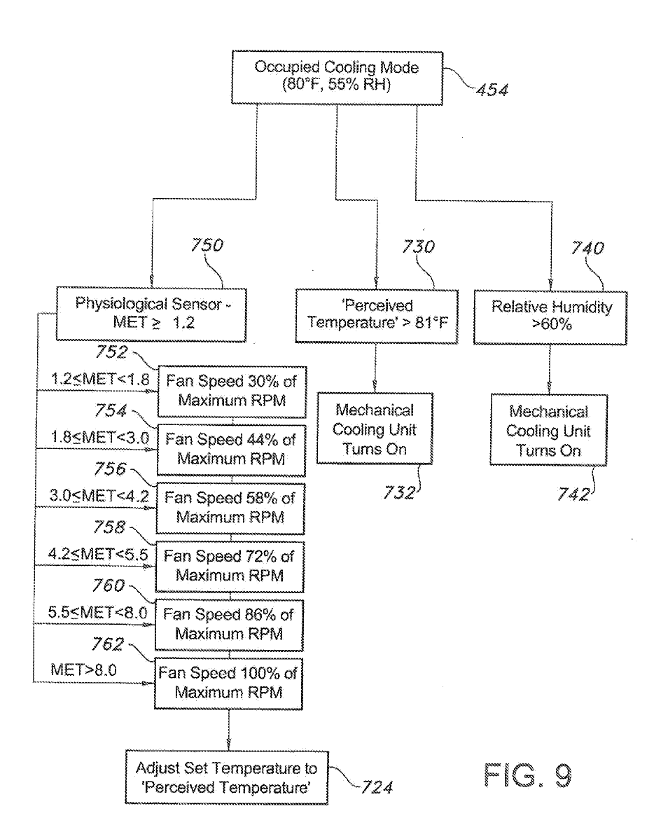

When the physiological sensor (190) communicates to the master control system (160) that the user's condition has exceeded a minimum threshold, such as MET≧1.2 (750), the master controller system may activate fan(s) (110). Master control system (160) may increase the speed of fan(s) (110) as the user's measured MET increases (752, 754, 756, 758, 760, 762) until the fan speed reaches 100) of the maximum fan speed (762), as shown in FIG. 9. The air movement created by fan(s) (110) creates a lower effective temperature by increasing the rate of heat transfer from the body.

Master control system (160) may adjust the set dry bulb temperature to a higher actual set dry bulb temperature that accounts for the perceived cooling effect (724), while maintaining a perceived temperature at the original set effective temperature, 80° F. The control logic utilized by master control system (160) to determine the effective temperature may be derived from the SET method of the ASHRAE Standard 55-2010 and/or other relevant comfort related theory or research. The effective temperature may be based upon the temperature, relative air humidity, and/or air speed, as well as the user's physiological condition, among other conditions which may exist. If the effective temperature rises above original set effective temperature (730), then master control system (160) may activate HVAC system (170) (732). If the relative humidity level rises above the optimum relative humidity (740), then master control system (160) may also activate HVAC system (170) (742) (i.e. regardless of what the actual or effective temperature may be). The use of data from a physiological sensor (190) may be utilized by the master control system (160) alone or in combination with data from any other sensor (130, 140, 150, 180) in adjusting fan speed to account for a change in effective temperature.

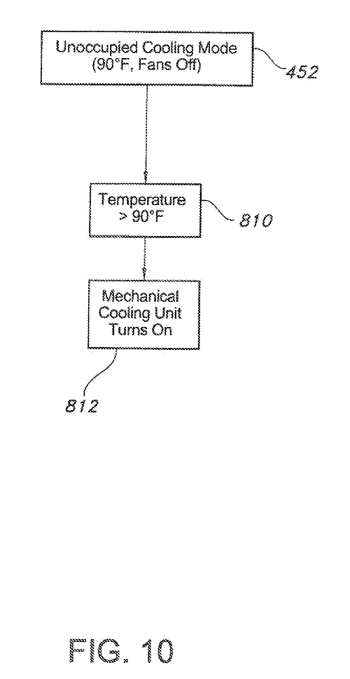

As yet another merely illustrative example, suppose that master control system (160) had automatically chosen and/or the occupant had manually chosen the “Unoccupied Cooling” mode (452), and set the temperature at 90° F. As shown in FIG. 10, fan (110) may remain off even if HVAC system (170) has been activated by master control system (160), because the cooling effect of the air is not useful in an unoccupied room. If the temperature rises above the original set temperature (810), then master control system (160) may activate HVAC system (170) (812). Of course, any other suitable temperature and/or relative humidity level values may be used in “Unoccupied Cooling” mode (452).

Thermal comfort control system (100) could be used in combination with a radiant heating system (e.g. radiant heat flooring, steam pipe radiator systems, etc.) in addition to or in lieu of being used with HVAC system (170). Thermal comfort control system (100) may operate as discussed above to determine and change or maintain the effective temperature at the level of occupancy within a room. Fans (110) may be utilized to evenly distribute heat from the radiant heat source throughout the entire space. This may improve energy efficiency and decrease warm-up and/or cool-down time within the space.

Thermal comfort control system (100) may be programmed to learn preferences of the occupant over a period of time. As an example of such a capability, master control system (160) may determine, as a result of the occupant's preferences over time, that the occupant prefers a certain relative humidity level in combination with a particular fan speed and/or dry bulb temperature setting, or vice versa. Such preferences may be established for particular periods of time, for instance during particular times of the year such that master control system (160) may establish different occupancy preferences for different times during the year; or such preferences may be established for particular external conditions which may exist as discussed above such that master control system (160) may establish different occupancy preferences for different external conditions.

Exemplary thermal comfort control system (100) may provide zone-based thermal control whereas traditionally an HVAC system (170) is controlled across a multitude of rooms or zones. Sensors (130, 140, 150, 180) may be placed in multiple rooms or zones and the occupant may establish an average temperature set range for use throughout all the rooms or zones, or the occupant may establish individual temperature set ranges particular to each room or zone.

Master control system (160) may determine appropriate control responses based upon the average or particular effective temperature set range and the thermal and/or occupancy conditions which may exist in each individual room or zone in which sensors (130, 140, 150, 180) are located. Master control system (160) may activate or shutdown particular fans (110) and/or may activate or shutdown HVAC system (170) in a particular zone or room depending upon the sensed thermal and/or occupancy conditions. Thus, while the average dry bulb temperature across a zone may not exceed the set range to activate HVAC system (170), fans (110) in occupied rooms may be activated by master control system (160) to increase comfort in those rooms while fans (110) in unoccupied rooms remain idle to reduce power consumption.

Automated dampers may also be included within HVAC system (170) to rebalance HVAC system (170) by automatically diverting air to occupied zones and away from unoccupied zones. Such dampers would allow master control system (160) to divert air that would otherwise be wasted on unoccupied zones to those zones which are occupied. The automated dampers may be driven by motors, solenoids, etc. that are in communication with master control system (160). Master control system (160) may be capable of maintaining a lower dry bulb temperature (in winter) or higher dry bulb temperature (in summer) in those rooms that are unoccupied, for instance by varying the dry bulb temperature limit by 2° F-3° F. until a room becomes occupied. As described in more detail below, master control system (160) may be integrated with other thermal control products in each room or zone to facilitate more efficient climate control.

The master control (160) may include a module, such as a display, for allowing for the control to be undertaken as well. The control (160) may allow for the user to override the independent control of the fans in the space, or require the fans to operate in a certain sequence over time based on sensed condition. The control (160) may also allow for the sensed condition that triggers adjustments in the fan regulation to be controlled, including possibly by causing the fan(s) in the zone(s) to turn on when a certain condition is sensed, turn off when a certain condition is sensed (time, temperature, light, etc.), or otherwise regulate the speed based on sensed conditions.

Another benefit of the exemplary thermal comfort control system (100) is that it may provide scheduled thermal control, whereas traditionally an HVAC system (170) ran around the clock. Master control system (160) may be programmed to operate fans (110) and/or HVAC system (170) only during particular times. An example of such a time may be when the occupant is typically at work. Master control system (160) may also be programmed to determine appropriate control responses based upon different settings or effective temperature set ranges during particular times. An example of such a time may be when the occupant is sleeping; thermal control system (160) may be programmed to a lower effective temperature set range (during winter) or a higher effective temperature set range (during summer) during this time, and then may begin to raise (during winter) or lower (during summer) the effective temperature at a time just before the occupant typically awakens. The system (160) may also regulate window coverings or openings if high humidity is sensed in a particular location, such as showering in a bathroom.

Master control system (160) may also be programmed to operate fans (110) and/or HVAC system (170) only during particular times based on a “room name” that is programmed into master control system (160) and associated with a particular room and a typical occupancy of such a room. As an example of such an operation, a room may be programmed into master control system (160) as “bedroom” and master control system (160) may automatically determine that fans (110) and/or HVAC system (170) need only be operated during typical occupancy periods of a bedroom, for instance, at night when the occupants are typically sleeping. Master control system (160) may also be capable of learning the occupancy habits within particular spaces. For instance, master control system (160) may determine that the occupant typically only uses a particular space during a particular period of time, and therefore only operate fans (110) and/or HVAC system (170) during that particular time to save energy. Finally, master control system (160) may be programmed to only operate fans (110) or HVAC system (170) within occupied zones regardless of the arbitrary location of sensors (130, 140), which may or may not be the same location as the occupied zone.

Thermal comfort control system (100) may also be utilized to assist in improving the efficiency of artificial lighting within a particular space. Light sensors may be incorporated on or within fans (110) and/or sensors (130, 140, 150, 180) to measure a light level within a particular space. Master control system (160) may be integrated with the artificial lighting within a particular space, and when the light level of a particular space exceeds a predetermined or programmed level, the artificial lighting may be dimmed until the light level reaches the predetermined or programmed level. As discussed below, master control system (160) may be integrated with automated blinds within a particular space, and when the light level of a particular space falls below the predetermined or programmed level, master control system (160) may open the automated blinds to utilize natural lighting, and if necessary, master control system (160) may brighten the artificial lighting until the light level reaches the predetermined or programmed level. Automated blinds could also be automatically opened to assist with heating in winter during the day; or be automatically closed to reduce the cooling load in the summer during the day. Other suitable ways in which automated blinds may be integrated with system (100) will be apparent to those of ordinary skill in the art in view of the teachings herein.

Thermal control system (100) may also be programmed for less routine events, such as vacation (“Vacation Mode”), when, as described above, thermal control system (100) may shutdown fans (110) and/or HVAC system (170) or determine appropriate control responses based upon different settings or temperature set ranges. Such a Vacation Mode or other less routine operations may be manually triggered by the occupant and/or automatically triggered by thermal control system (100) after a lack of occupancy is sensed for an established threshold period. During Vacation Mode, master control system (160) may increase energy efficiency by not operating HVAC system (170) and/or fan(s) (110), or by operating HVAC system (170) and/or fan(s) (110) at more efficient energy levels. As discussed below, such operations may be tied into other any number of climate control products. In addition, system (100) may reset or otherwise reduce power consumption by a water heater and/or other equipment capable of such control during a Vacation Mode.

Thermal comfort control system (100) may be integrated with a NEST™ thermostat system by Nest Labs, Inc. of Palo Alto, Calif. Such integration may allow for the NEST™ thermostat system to receive information from and/or control the components of thermal comfort control system (100); including HVAC system (170), fan(s) (110) and/or sensors (130, 140, 150, 180) among others. Fan(s) (110) and/or sensors (130, 140, 150, 180) may also serve as a gateway into other devices and bring all of those points back to the NEST™ thermostat system. As merely an example of other devices, smart plugs for advanced energy monitoring may be coupled with the NEST™ thermostat system via fans (110) and/or sensors (130, 140, 150, 180). Integration may also allow the programmed or learned periods of occupancy discussed above to be included in the NEST™ thermostat system. Master control system (160) may communicate energy usage to the NEST™ thermostat system. Master control system (160) may also be programmed to operate as a NEST™ thermostat controller in addition to or in lieu of a NEST™ thermostat controller. Fan (110) energy usage, as discussed above, may be communicated to the NEST™ thermostat system. Finally, the operating hours of fan(s) (110), as determined by the programmed or learned period of occupancy as discussed above, may be included in the data logging of the NEST™ thermostat system. As yet another merely illustrative example, thermal comfort control system (100) may be integrated with an IRIS™ system by Lowe's Companies, Inc. of Mooresville, N.C. Other suitable systems and/or components that may be combined with system (100) will be apparent to those of ordinary skill in the art in view of the teachings herein. A further example is the Ecobee Smart thermostat.

As shown in FIG. 3, exemplary thermal comfort control system (100) described above may be combined with any number of climate and environmental control products, and the capabilities and operations discussed above may be configured to include any number of climate and environmental control products. An example of such an additional product would be automated blinds (920) that may be opened or closed (fully or modulated to a particular amount) depending upon the light levels being introduced into the space at any particular moment. The blinds (920) may also be set in a “privacy” mode to prevent them from being opened when intentionally closed (or, in the case of vertical blinds, to cause them to only partially open, such as from the top down).

Another example of such a product would be an air purifier (922) that may be utilized to improve the air quality within a room based upon air quality measurements taken by sensors (130, 140) described above. Yet another example of such a product would be an air humidifier or dehumidifier (924) to control the relative humidity within a room based upon the relative humidity measurements taken by sensors (130,140). Yet another example of such a product would be a water heater (926). Yet another example of such a product would be a scent generator (928) which may include an air freshener to distribute aromatic scents throughout all the spaces or only particular spaces. Master control system (160) may also be integrated with other network systems that will allow for additional features to be controlled such as lighting and music among others.

In one approach, the system (100) incorporating the master control system (160) is adapted for sensing or estimating the effects of external radiation on the thermal comfort of the occupant(s) of associated space(s), and controlling one or more of the fan (110) or the HVAC system (170) as a result. In one example, this may be achieved by providing a sensor for sensing the amount of radiant energy, such as a radiant heat flux sensor (1000), which may be placed on or adjacent to a window associated with the space or other structure representative of the amount of radiant flux associated with the space (e.g., a solar tube, portal, or the like). An example of a radiant heat flux sensor may be found at http://www.captecentreprise.com/prod02.htm (incorporated herein by reference), but this is not meant to limit the disclosure to any particular form, including based on after-arising technology for sensing radiant heat flux.

The radiant heat flux determination may be used to automatically control the environmental conditions. For example, the sensed heat flux may be used to regulate an automated window or window shade (including possibly the degree of opening or closing), such as automated blinds (920), in an effort to control the effects of solar emissions on the space and its occupants, if present. For example, if it is determined that the radiant heat flux is below a particular value, then the amount of light entering the space from outside may be controlled by controlling the blinds (920) to open (partially or fully). Likewise, if radiant heat flux is determined to be above a particular value, then the light entering the space may be regulated to ameliorate the resulting thermal effects, such as by controlling the blinds (920) to close (and then further with the control of the fan (110) and/or the HVAC system (170)). This regulation of the light penetration from outside may also be done in connection with the master control system (160) sensing the indoor light intensity in the space, such as using a light sensor (1010), which may also be used to modulate the amount of artificial lighting supplied from an electric light (L) (which may be associated with the fan (110) or otherwise arranged for providing illumination to the space) in order to maintain a particular value, such as a set point indicated by a user. In lieu of or in addition to a radiant heat flux sensor, a fenestration surface temperature sensor (1020) may also be used to determine the surface temperature adjacent to a window, and a solar intensity sensor (1030) may be used to determine the amount of solar intensity.

In situations where windows are positioned on different sides of a space, the system (160) may use the inputs from multiple radiant flux sensors in order to regulate the amount of light provided in the space. For instance, if a radiant flux sensor associated with a window facing east in the morning is receiving direct sunlight, it may close the associated covering, while opening another facing west to admit indirect sunlight (and combined with possible regulation of the artificial lighting in order to meet any set value). The reverse operation can be done in the evening, when the sunlight is projected onto the western-facing window. Strategically positioned artificial lights may also be used to compensate for the different amounts of light admitted through the different windows.

The system (160) logic may also operate based on predicted conditions, such as weather reports (which may be received wirelessly, such as over the internet). For example, if a sunny day is predicted, then the system (160) may regulate the window covering (e.g., automated blinds 920) differently than if a cool, cloudy day is predicted Likewise, the system (160) may also regulate the control of the fan(s) (110) or HVAC system (170) accordingly. The prediction may be based on known reactions of the system during similar past weather events (e.g., the fan, HVAC system, or window covering changes during a day when the dry bulb temperature, humidity, and/or amount of sunlight were similar or the same as predicted). The prediction may also be time-based, such that the system (160) attempts to regulate the effective temperature using the fan (110) in the morning when conditions are cooler, as compared to later in the day when the dry bulb temperature normally rises.

As mentioned above, the system (160) may also be used to control the selective opening and closing (and the degree to which such are opened or closed) of natural sources of ventilation, such as windows or vents. This opening or closing may be based on one or more of indoor dry bulb temperature, occupancy conditions, heat flux, or may be done based on an estimated or actual wind speed, and may be done using an associated motor for controlling the window position (e.g., between open and closed, or among a plurality of open positions, depending on the desired degree of ventilation). The wind speed may be determined based on a received report, or based on an actually sensed wind speed at a location adjacent to the window, such as by a wind speed sensor (1040). Thus, the sensed wind speed may be used to determine if the window should be modulated to be opened to a particular degree (thus leading to ventilation of the spaced and potentially enhanced comfort) or closed to a particular degree, which may also be done based on the set point selected by the user. The wind speed may also be used to control the speed of any fan (110) in the space in the event a window is open to aid in controlling heating or cooling. The HVAC system (170) may also be turned off or disabled by the system (160) if the window is open or controlled to be open, so as to avoid wasting energy. The system (160) may also be set to a security mode to prevent the window from being opened or otherwise adjusted from a pre-determined setting. Alternatively, in lieu of automated windows, the system (160) may indicate to the user the desirability of manually opening or closing window(s) in order to achieve the desired set temperature, such as by providing an alarm or sending an e-mail, text message, or like communication to a computing device, such as a mobile phone.

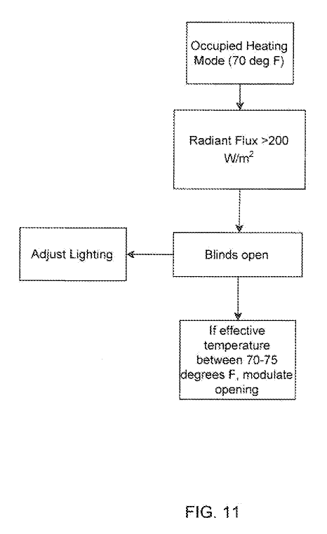

As a merely illustrative example, suppose that master control system (160) had automatically chosen and/or the occupant had manually chosen “Occupied Heating” mode, and set the dry bulb temperature at 70° F., as indicated in FIG. 6. If the dry bulb temperature sensed in the space is less than the set temperature, the HVAC system shall activate to maintain the dry bulb temperature at the set point. The master control system (160) will also control the ceiling fan (110) to be on at a given speed, which may be pre-determined or adaptive based on known user preferences (or, for example, measured wind speed, as noted above). Furthermore, as indicated in FIG. 11, the master control system (160) may operate to control the amount of light in the room, such as by controlling artificial or natural lighting. For example, if the sensed radiative heat flux exceeds a particular amount, such as 200 W/m² (which may be pre-programmed and/or regulated or set by the user), the system (160) shall control the blinds (920) to open fully, unless set to privacy mode (which, as noted above, may include a degree of partial opening while retaining privacy in some situations). Furthermore, the system (160) may in such instance control the lighting in the space to maintain a desired amount of lighting, which may be set by the user. If the temperature is between the set point and a predetermined upper value (e.g., 75° F.), the opening of the blinds (920) will be modulated to minimize the change in temperature and without causing perceptible changes in the ambient light (such as determined by light sensor 1010). When the temperature is below the set point, the blinds (920) will be completely opened; when the temperature is above the upper value, the blinds (920) shall be closed. Otherwise, the blinds (920) are closed.

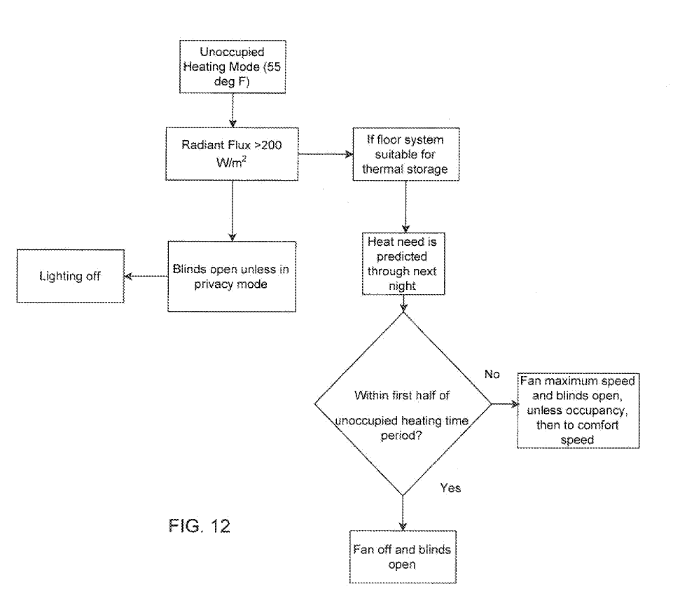

As another merely illustrative example, suppose that master control system (160) had automatically chosen and/or the occupant had manually chosen “Unoccupied Heating” mode, and set the dry bulb temperature at 55° F., as indicated in FIG. 7. If the dry bulb temperature sensed is less than the set temperature, the HVAC system (170) shall activate to maintain the dry bulb temperature at the set point. The master control system (160) shall also control the ceiling fan (110) to be on at a minimum operating speed in order to provide a minimal level of air circulation. As indicated in FIG. 12, the blinds (920) shall be opened if the sensed radiative heat flux exceeds the pre-determined value (unless set to privacy mode), and the light(s) (L) shall be turned off. Otherwise, the blinds (920) shall be closed.

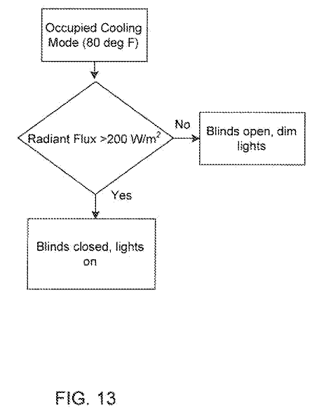

As yet another merely illustrative example, suppose that master control system (160) had automatically chosen and/or the occupant had manually chosen “Occupied Cooling” mode, and set the dry bulb temperature at 80° F., as indicated in FIG. 8. If the dry bulb temperature sensed exceeds the set dry bulb temperature, the HVAC system (170) shall activate to maintain the dry bulb temperature at the set point. The master control system (160) shall also control the ceiling fan (110) to be on at a particular speed. As indicated in FIG. 13, the blinds (920) shall be closed if the sensed radiative heat flux exceeds the pre-determined value, and the light(s) (L) shall be turned on to maintain the desired amount of lighting. Otherwise, the blinds (920) shall be open and the lights shall be dimmed (unless set to privacy mode).

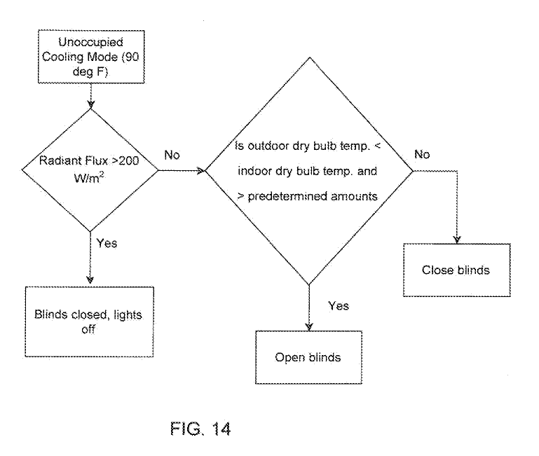

As yet another merely illustrative example, suppose that master control system (160) had automatically chosen and/or the occupant had manually chosen the “Unoccupied Cooling” mode, and set the dry bulb temperature at 90° F. If the dry bulb temperature sensed exceeds the set dry bulb temperature, the HVAC system (170) shall activate to maintain the temperature at the set point. The master control system (160) shall also control the ceiling fan (110) to be off. The blinds (920) shall be closed if the sensed radiative heat flux exceeds the pre-determined value, and the light(s) (L) shall turn off, as indicated in FIG. 14. If the outdoor dry bulb temperature is sensed to be less than the indoor dry bulb temperature, the indoor dry bulb temperature is greater than a particular amount (e.g., 75° F.), and the radiative heat flux is less than the predetermined amount, the blinds (920) shall open (unless set to privacy mode). Otherwise, the blinds (920) shall be closed.

An example of a predictive algorithm based on one or more weather conditions is also provided. In this example, the system (160) is provided information early in the day on the predicted weather for the day, which for example is a predicted outdoor dry bulb temperature of 85° F. and sunny conditions. The system (160) then looks for any previous similar days and, based on locating a match, determines that it is highly likely that the HVAC system (170) will be heavily used in cooling mode to maintain comfort in the space, which is what occurred during the prior conditions. Using this as a past protocol, a current protocol is developed, which may involve keeping the blinds (920) closed all morning to minimize solar heat gain into the space, even though the system (160) might normally have opened them. By minimizing heat gain early in the day, the space dry bulb temperature increases more slowly and the HVAC system (170) would start to operate later than would otherwise be the case. In the meantime, the fan (110) may be used to provide cooling until the set dry bulb temperature is exceeded. If window controls are included, the system (160) could also open the windows at night to pre-cool the space before the air temperature rises during the day, thus further delaying the use of the HVAC system (170). The wind direction could also be used for control, such as by opening and closing certain windows for increased ventilation or to ensure a cross breeze.

According to another aspect of the disclosure, a system and method of thermal control may utilize the thermal mass of a partition in the space, such as a wall, ceiling, floor or flooring system (hereinafter “floor”) to store solar heat energy acquired during the day for use at night. As background, large thermal mass objects (such as building foundations) will store and release heat slowly over long periods of time. If sunlight happens to shine on a thermal mass, then that mass can increase temperature far above ambient air conditions and maintain that elevated temperature long after the sun stops shining. Traditionally, solar heating using thermal masses was only a passive technique. This function aims to increase the usefulness of solar thermal mass heating. However, this disclosure proposes modulating heat availability through shading control and convective extraction (using ceiling fan).

Certain parameters may be evaluated for determining whether to operate in a thermal storage mode (TSM). Parameters allowing for thermal storage mode (TSM) may include the amount of solar flux available for a given space (e.g., if solar flux is greater than a particular threshold, such as the 200 W/m² value noted above). Also, the criteria may include examining whether the thermal storage potential of the partition, such as the floor, is sufficient to maintain a predetermined temperature difference (for example, more than 50% of a greater than 5° F. delta temperature difference over room temperature for more than 2 hours under typical solar flux). This criteria could be determined by thermal calculations (see example below) or by learned thermal reaction of building materials (such as by measuring temperature change of the floor after shade closure and recording time to 50% temperature decrease). If over a particular period of time, such as several days, this recorded time is greater than a predetermined amount (e.g., 2 hours), then the floor is sufficient for thermal storage.

Thermal calculations may then be done using the following user inputs and thermal property lookup tables based on those inputs: (1) floor construction type; (2) floor covering; and (3) occupancy prediction. The construction of the floor determines how much energy can be stored and for how long that energy will take to move into and out of the floor, and could be determined using user input (choice of floor type; slab on grade, crawl space, second floor, etc.). The insulation value of the floor will also influence how fast solar energy can be stored or extracted from a floor. This could be determined using user input (choice of floor covering; tile, thick carpet, office carpet, bare slab, etc.).

Occupancy prediction may be done using, for example, thermostat away settings (e.g., if the user specifies that they will be “away” during a certain period of the day, then that unoccupied time period can be used for thermal storage functionality). Alternatively, the system could use motion sensor data over multiple days to predict when the occupant will be away from home on given days of the week.

An example of the calculation used to determine if a particular floor is suitable for thermal storage is provided. Assume the floor is a polished concrete slab of 0.1 meter thickness (Th) with no carpet, and that the time to maintain the temperature difference is 2 hours (dt), in which case:

$${c}_{p} = 0.8 \frac{1000 J}{kg \cdot K}$$

$$ρ = 2400 \frac{kg}{{m}^{3}}$$

$$dT = ( 5 \cdot \frac{5}{9} ) K$$

Presuming a 5 degree F. floor to air difference exists, the energy storage can be calculated as follows:

$$Q = ρ \cdot Th \cdot {c}_{p} \cdot dT = 5.333 \cdot {10}^{5} \frac{J}{{m}^{2}}$$

The heat loss due to convection for a slab may be determined as follows:

$${q}_{conv} = h \cdot dT = 25 \frac{W}{{m}^{2}}$$

Where the convection coefficient of a horizontal plane in still air is:

$$h = 9 \frac{W}{{m}^{2} K}$$

The heat loss due to radiation from the floor to walls may be estimated as follows:

$${q}_{rad} = \frac{σ \cdot ( {( 23 ° C . + dT )}^{4} - {( 23 ° C . )}^{4} )}{\frac{1}{{ɛ}_{concrete}} + \frac{1}{{ɛ}_{wall}} - 1}$$

### Where:

ε_{concrete}=0.63

ε_{wall}=0.92

σ=Stefan−Boltzmann constant

Accordingly, the thermal storage potential for the floor may be evaluated as follows:

$$\frac{( {q}_{rad} + {q}_{conv} ) \cdot dt}{Q} = 0.471$$

As this is less than 50%, the floor is determined sufficient for thermal storage.

As indicated in FIG. 12, the thermal storage mode of operation may be implemented in connection with the thermal comfort control as outlined in the foregoing description. First, it is determined whether a particular floor is found to be sufficient for thermal storage. If so, then it is determined whether heat need is predicted throughout the majority of the next night (such as based on a historical observation, a predicted forecast, or user input). Also, by way of a controller, such as master controller (160), it is determined whether unoccupied heating mode is active during the day, and also whether the solar flux is above threshold.

If these conditions are met, then one or more controller for regulating an environmental condition would be controlled accordingly. For example, fans for circulating air in the space would be turned off or controlled to remain off for a predetermined time, such as for first half of predicted unoccupied time period, and the blinds (or other window covering) would remain open. If the predetermined time is exceeded, then the air circulation devices would be run, preferably at the maximum possible speed, and the blinds would remain open. If occupancy is reestablished at any time, then the speed of the device(s) would be reduced to a maximum speed that satisfies occupant comfort, as described above, again with the blinds open. If thermal reservoir is depleted (which may be sensed using non-contact temperature sensor), then the thermal mode of operation may be discontinued.

As used herein, the term “window” is considered to include any opening constructed in a wall, door, or roof that functions to admit light or air into a space. Hence, the term window may include skylights or like structures. As used herein, the term “window” is synonymous with “fenestration,” as that term is used in ASHRAE Standard 90.1-2013, which is incorporated herein by reference.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of claims that may be presented, and is understood not to be limited to the details of structure and operation shown and described in the specification and drawings.

1. An environmental control system for a space including at least one window adapted for admitting light into the space, comprising:
an environmental controller for regulating an environmental condition;
at least one first sensor for sensing an amount of radiant energy associated with the space and generating an output; and
a controller for controlling the operation of the environmental controller based on the output.

2. The control system of claim 1, wherein the environmental controller is selected from the group consisting of a fan, a light, an HVAC system, a window, a window covering, or any combination of the foregoing.

3. The system of claim 2, wherein the environmental controller comprises an automated window covering for being opened and closed by the controller, said controller adapted for maintaining the automated window covering in a closed condition when a privacy setting is selected.

4. The system of claim 2, wherein the light is attached to a ceiling fan comprising the fan, and is regulated based on the sensor output.

5. The system of claim 1, further including a second sensor selected from the group consisting of a light sensor, a temperature sensor, a humidity sensor, an occupancy sensor, a wind speed sensor, and any combination of two or more of the foregoing sensors, and wherein the controller controls the operation of the environmental controller based on a second output of the second sensor(s).

6. The system of claim 5, wherein the second sensor comprises a temperature sensor, and further including a set temperature provided by a user, and wherein the controller controls one or more of a ceiling fan, an HVAC unit, an automated window covering, and a light based on a comparison of the output of the temperature sensor and the set temperature.

7. The system of claim 6, further including an occupancy sensor, and wherein the controller controls one or more of the ceiling fan, the HVAC unit, the automated window covering, and the light based on the output of the occupancy sensor.

8. The system of any of the foregoing claims, wherein the controller is adapted for receiving a predicted weather condition and controlling the environmental controller based on the predicted weather condition.

9. The system of claim 1, wherein the environmental controller comprises an automated window, and further including a wind speed sensor for communicating with the controller to determine whether to open the window automatically.

10. The system of claim 1, wherein the environmental controller comprises an automated window, and further including a wind direction sensor for communicating with the controller to determine whether to open the window automatically.

11. The system of claim 1, wherein the controller is adapted for sending an alert to a user to indicate the desirability of opening or closing a window associated with the space based on the output of the sensor.

12. The system of claim 1, wherein the sensor comprises a radiant heat flux sensor.

13. The system of claim 1, wherein the controller is adapted for determining whether a partition in the space is useful for providing heat to the space based on the sensed amount of radiant energy and wherein, upon determining that the partition is useful for providing heat to the space, the controller regulates the environmental controller to operate according to a pre-determined setting.

14. An environmental control system for a space, comprising:
a fan for causing air circulation within the space;
a sensor for sensing an amount of radiant energy associated with the space and generating an output; and
a controller for controlling the operation of the fan based on the sensor output.

15. The system of claim 14, further including an HVAC system controlled by the controller based on the sensor output.

16. The system of claim 15, wherein the controller regulates one or both of the fan or the HVAC system to operate based on the sensor output.

17. The system of claim 14, further including an automated window covering, and wherein the controller regulates the automated window covering based on the sensor output.

18. The system of claim 14, further including an automated window, and wherein the controller regulates the automated window based on the sensor output.

19. The system of claim 14, wherein the controller is adapted for determining whether a partition in the space is useful for providing heat to the space based on the sensed amount of radiant energy.

20. The system of claim 14, wherein, upon determining that the partition is useful for providing heat to the space, the controller regulates the fan to operate according to a pre-determined setting.

21. The system of any of claims 14-20, wherein the sensor comprises a radiant heat flux sensor.

22. An environmental control system for a space, comprising:
at least one window adapted for being opened to at least one position for admitting air into the space;
a sensor for sensing a condition in the space and generating an output; and
a controller for regulating the window position based on the sensor output.

23. The system of claim 22, wherein the controller issues a control signal for modulating a motor associated with the window to cause the window to open.

24. The system of claim 22, wherein the controller issues an alert to a user relative to the opening of the window.

25. The system of claim 24, wherein the alert is in the form of an electronic message including user-perceptible information.

26. The system of claim 22, wherein the sensor is selected from the group consisting of a temperature sensor, a humidity sensor, an occupancy sensor, a radiant flux sensor, a wind speed or direction sensor, a solar intensity sensor, or any combination of two or more of the foregoing sensors.

27. The system of claim 22, wherein the controller is adapted for determining whether a partition in the space is useful for providing heat to the space based on the sensed amount of radiant energy.

28. An environmental control system for a space associated with at least one window adapted for admitting light or air into the space, comprising:
a fan for circulating air within the space;
a sensor for sensing a condition associated with the space; and
a controller for controlling the operation of the fan and a state of the window based on the sensor output.

29. The system of claim 28, wherein the window includes an automated blind, and the controller is adapted for controlling the amount of light passing through the window into the space as the state of the window.

30. The system of claim 28, wherein the window comprises an automated window, and the controller is adapted for controlling the amount of air passing through a window opening into the space as the state of the window.

31. An environmental control system for a space including at least one window adapted for admitting light into the space and a partition, comprising:
a fan for circulating air within the space;
at least one first sensor for sensing an amount of radiant energy associated with the space and generating an output; and
a controller for controlling the fan based on the sensor output.

32. The system of claim 31, wherein the controller is adapted for determining whether the partition in the space is useful for providing heat to the space based on the sensed amount of radiant energy and wherein, upon determining that the partition is useful for providing heat to the space, the controller controls the fan to operate according to a pre-determined setting.

33. A method of controlling an environmental condition in a space, comprising:
regulating an environmental condition of the space based on a sensed radiant heat flux associated with the space.

34. A method of controlling an environmental condition in a space, comprising:
controlling at least one window adapted for being opened to at least one position for admitting air into the space based on an sensed condition in the space.

35. A method of controlling an environmental condition in a space, comprising:
controlling one or more of a window, a window covering and a fan based on a detected value of a temperature in the space; and
when the detected temperature is above or below a pre-determined value, activating an additional system for regulating the temperature in the space.

36. The method of claim 35, wherein the additional system comprises an HVAC system.

37. A method of regulating environmental conditions in a space including a window, comprising:
based on a pre-determined temperature setting, a state of occupancy, and a radiant heat flux value, regulating one or more of:
(i) a fan for circulating air in the space;
(ii) an HVAC system for controlling the temperature of the space;
(iii) a covering for at least partially covering the window; and
(iv) a light for providing artificial light to the space.

38. The method of claim 37, wherein if the space is occupied and heating is desired, the HVAC unit is activated to supply heated air to the space in an effort to reach the pre-determined temperature setting, the fan is regulated on at a minimal speed, the covering is regulated to uncover the window if the radiant heat flux value exceeds a predetermined amount, and the light is regulated to provide for a pre-determined amount of light.

39. The method of claim 37, wherein if the space is unoccupied and heating is desired, the HVAC system is activated to supply heated air to the space in an effort to reach the pre-determined temperature setting, the fan is regulated on at a minimal speed, and the covering is regulated to uncover the window if the radiant heat flux value exceeds a predetermined amount, and light is regulated to provide for a minimal amount of light.

40. The method of claim 39, further including the step of determining whether a partition in the space is useful for providing heat to the space based on the radiant heat flux value, and regulating the fan according to a pre-determined setting.

41. The method of claim 37, wherein if the space is occupied and cooling is desired, the HVAC system is activated to supply cooled air to the space in an effort to reach the pre-determined temperature setting, the fan is regulated on at a speed greater than a minimal speed, the covering is regulated to cover the window if the radiant heat flux value exceeds a predetermined amount, and the light is regulated to provide for a pre-determined amount of light.

42. The method of claim 37, wherein if the space is unoccupied and cooling is desired, the HVAC system is activated to supply cooled air to the space in an effort to reach the pre-determined temperature setting, the fan is regulated to be off, and the covering is regulated to cover the window if the radiant heat flux value exceeds a predetermined amount.

43. A method of regulating natural light admitted to a room through a plurality of windows, comprising:
using a controller, regulating a first window covering on a first window based upon a predicted or actual amount of natural light available to pass through the first window; and
using the controller, regulating a second window covering on a second window based upon the predicted or actual amount of natural light available to pass through the second window.

44. The method of claim 43, wherein the regulating steps are performed based upon a direction the first and second windows face and the time of day.

45. The method of claim 43, wherein the regulating steps are performed based upon a sensed radiant heat flux associated with the first or second window.

46. A method of regulating environmental conditions in a space, comprising:
based on a predicted weather condition, using a controller to control the operation of an environmental controller, such as a window to admit air into the space or a window covering to admit light into the space.

47. The method of claim 46, wherein the controlling step is performed based on a comparison of the predicted weather condition and a control implemented as a result of a similar historic weather condition.

48. The method of claim 46, wherein the controlling step includes controlling one or both of a fan in the space and an HVAC system for supplying air to the space.

49. The method of claim 46, wherein the controlling step comprises controlling the window or window covering at a time before the predicted weather condition occurs.

50. A method of regulating environmental conditions in a space, comprising:
comparing a predicted weather condition with a historical weather condition;
based on the comparison, controlling an environmental controller for regulating an environmental condition of the space.

51. The method of claim 50, wherein the regulating step comprises operating the environmental controller according to a current protocol corresponding to a past protocol of operation during the historical weather condition.

52. A method of conditioning a space using thermal energy, comprising:
determining whether a partition in the space is useful for providing heat to the space;
upon determining that the partition is useful for providing heat to the space, regulating an environmental condition of the space.

53. The method of claim 52, wherein the determining step comprises determining an amount of radiant energy in the space.

54. The method of claim 52 or 53, wherein the determining step comprises determining the thermal storage potential of the partition.

55. The method of claim 52 or 53, wherein the determining step comprises determining a learned thermal reaction.

56. The method of claim 52, wherein the regulating step comprises controlling a fan associated with the space not to operate.

57. The method of claim 53, further including the step of operating the fan according to a pre-determined setting once the partition is no longer useful for providing heat to the space.

58. The method of claim 52, further including the step of predicting a heat need for the space prior to the determining step.

59. The method of claim 52, further including the step of determining whether the space is occupied.

60. The method of claim 59, wherein, if the space becomes occupied, then the method comprises regulating a fan to a setting corresponding to the presence of a person.
